(19) United States
(12) Patent Application Publication
(10) Pub. No.: US 2011/0111907 A1
(43) Pub. Date: May 12, 2011

(54) TRANSMISSION FOR HYBRID VEHICLE

(75) Inventors: Baekyu Kim, Hwaseong (KR); Kyungha Kim, Yongin (KR); Yeonho Kim, Suwon (KR)

(73) Assignee: HYUNDAI MOTOR COMPANY, Seoul (KR)

(21) Appl. No.: 12/840,138

(22) Filed: Jul. 20, 2010

(30) Foreign Application Priority Data
Nov. 12, 2009 (KR) 10-2009-0109077

(51) Int. Cl. F16H 3/72

(52) U.S. Cl. 475/5; 903/911

(57) ABSTRACT

A transmission for a hybrid vehicle is provided to implement one or more electric vehicle modes, two or more power split modes, and a plurality of fixed-gear ratio modes that can improve driving performance and fuel efficiency.

### CROSS-REFERENCE TO RELATED APPLICATIONS

The present application claims 35 U.S.C. §119(a) the benefit of Korean Patent Application No. 10-2009-0109077 filed Nov. 12, 2009, the entire contents of which application is incorporated herein for all purposes by this reference.

### BACKGROUND OF THE INVENTION

1. Field of the Invention

The present invention relates to a transmission for a hybrid vehicle, in detail, is a technology for a transmission for a hybrid vehicle having one or more electric mode (EV), two power split modes, and multiple fixed-gear ratio shift ranges.

2. Description of Related Art

Hybrid vehicles equipped with a hybrid transmission composed of an engine, a motor generator, and a planetary gear set can travel in an electric vehicle mode operated by only a motor usually at the start or low velocity and also in a power split mode allowing more efficiently using the power of the engine and the motor by operating the transmission as an electrically variable transmission (EVT) as the vehicle velocity increases. Further, the hybrid vehicles can use a fixed-gear ratio to improve power performance of the vehicles, similar to the existing transmissions. Systems based on this conception have contributed to maximize the idle stop function and regenerative brake and to improve fuel efficiency and power performance of vehicles.

Further, hybrid vehicles do not produce exhaust gas from the engine when being driven only by the motor generator and can operate the engine at the best fuel economy point, which is recognized as an environmental-friendly automobile technology having advantages of improving fuel economy and reducing exhaust gas.

The transmissions for the hybrid vehicles are designed to implement a variety of drive modes with a simpler configuration, such that, preferably, the vehicles can be efficiently driven while improving fuel economy and acceleration performance by switching the drive modes in accordance with the traveling conditions of the vehicles, thereby improving the traveling performance of the vehicles.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

An aspect of the present invention provides a transmission for a hybrid vehicle, which includes a first differential gear set, a second differential gear set, a first motor generator, a second motor generator, a first fixing mechanism, and a second fixing mechanism.

The first differential gear set includes at least four rotary members. The rotary members include a rotary member connected to an engine and two rotary members selectively connected with each other.

The second differential gear set includes at least three rotary members. The rotary members include a rotary member continuously connected to a rotary member of the first differential gear set and two rotary members each being connected to an output member, selectively connected to another rotary member of the first differential gear set, or both.

The first motor generator is continuously connected to a rotary member of the first differential gear set other than the rotary member connected to the engine and the rotary members selectively connected with each other.

The second motor generator is continuously connected to the rotary member of the second differential gear set continuously connected to the rotary member of the first differential gear set.

The first fixing mechanism is provided to restrict rotation of a rotary member of the second differential gear set other than the rotary member connected to the output member and the rotary member connected to the second motor generator.

The second fixing mechanism is provided to restrict rotation of the rotary member of the second differential gear set connected with the second motor generator.

Another aspect of the present invention provides a transmission for a hybrid vehicle, which includes a first planetary gear set, a second planetary gear set, a first fixing mechanism, a second fixing mechanism, a third torque transmission mechanism, a fourth torque transmission mechanism, a first motor generator, and a second motor generator.

The first planetary gear set that includes at least four rotary members. The rotary members include a rotary member connected to an engine and two rotary members selectively connected with each other.

The second planetary gear set includes at least three rotary members. The rotary members include a rotary member continuously connected to a rotary member of the first differential gear set and two rotary members each being connected to an output member OUTPUT, selectively connected to another rotary member of the first differential gear set, or both;

The first fixing mechanism and the second fixing mechanism restrict rotation of two rotary members of the second planetary gear set, respectively, other than the rotary member connected to the output member.

The third torque converter selectively connects/disconnects a rotary member of the first planetary gear set and a rotary member of the second planetary gear set.

The fourth torque converter selectively connects/disconnects two rotary members of the first planetary gear set.

The first motor generator is connected to a rotary member of the first planetary gear set.

The second motor generator is connected to a rotary member of the second planetary gear set.

With the transmissions of the present invention, fuel efficiency and driving performance of the vehicles can be improved.

The above and other features of the transmissions will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a diagram illustrating the configuration of a transmission for a hybrid vehicle according to a first embodiment of the present invention.

FIGS. 2 and 3 are diagrams showing a second and a third embodiments of the present invention.

FIG. 4 is a table showing operation modes implemented by the transmission of the first embodiment shown in FIG. 1.

FIGS. 5 to 12 are configuration views and lever diagrams illustrating the drive conditions of a power train including the transmission shown in FIG. 1 under the operation modes shown in FIG. 4.

FIG. 13 is a table showing operation modes implemented by the transmission of the second embodiment shown in FIG. 2.

FIGS. 14 to 21 are configuration views and lever diagrams illustrating the drive conditions of a power train including the transmission shown in FIG. 2 under the operation modes shown in FIG. 13.

FIG. 22 is a table showing drive modes implemented by the transmission of the third embodiment shown in FIG. 3.

FIGS. 23 to 29 are configuration views and lever diagrams illustrating the drive conditions of a power train including the transmission shown in FIG. 3 under the operation modes shown in FIG. 22.

FIGS. 30 and 31 are diagrams illustrating the configuration of a transmission for a hybrid vehicle according to modified embodiments of the first embodiment of the present invention.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

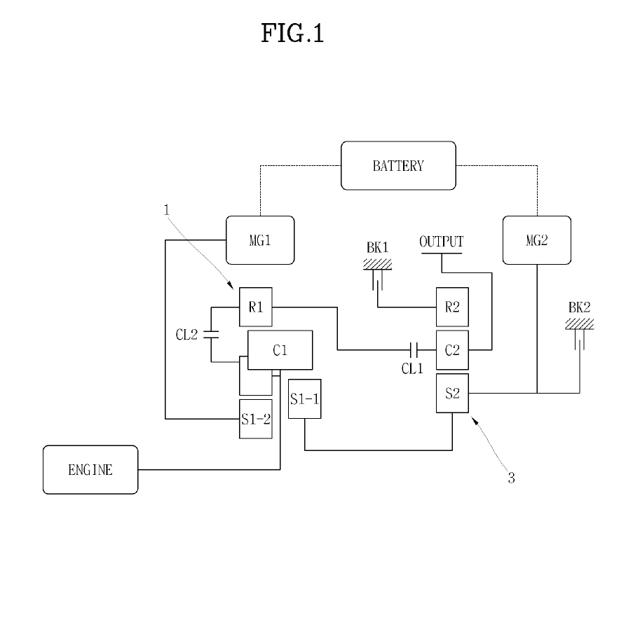

Referring to FIGS. 1 to 3, the first to third embodiments of the present invention commonly include a first differential gear set, a second differential gear set, a first motor generator MG 1, a second motor generator MG 2, a first fixing mechanism, a second fixing mechanism, a third torque converter, and a fourth torque converter.

The first differential gear set includes at least four rotary members. The rotary members include a rotary member connected to an engine ENGINE and two rotary members selectively connected with each other.

The second differential gear set includes at least three rotary members. The rotary members include a rotary member continuously connected to a rotary member of the first differential gear set and two rotary members each being connected to an output member OUTPUT, selectively connected to another rotary member of the first differential gear set, or both.

The first motor generator MG1 is continuously connected to a rotary member of the first differential gear set other than the rotary member connected to the engine ENGINE and the rotary members selectively connected with each other.

The second motor generator MG2 is continuously connected to the rotary member of the second differential gear set continuously connected to the rotary member of the first differential gear set.

The first fixing mechanism is provided to restrict rotation of a rotary member of the second differential gear set other than the rotary member connected to the output member OUTPUT and the rotary member connected to the second motor generator MG2.

The second fixing mechanism is provided to restrict rotation of the rotary member of the second differential gear set connected with the second motor generator MG2.

The third torque converter is disposed to selectively connect or disconnect a rotary member of the second differential gear set and a rotary member of the first differential gear set.

The fourth torque converter is disposed to selectively connect or disconnect two rotary members of the first differential gear.

Although it is described that the first differential gear set and the second differential gear set are implemented by planetary gear sets in these embodiments, they may also be implemented by other types of gear sets that make at least one gear have a rotational velocity that is the weighted average velocity of the other two gears, using bevel gears etc.

Preferably, the first differential gear set is implemented by a revenue type planetary gear set and referred to as a first planetary gear set 1 and the second differential gear set is implemented by a simple planetary gear set and referred to as a second planetary gear set 2.

Preferably, the first planetary gear set 1 includes a first sun gear S1-1, a first sun gear S1-2, a first carrier C1, and a first ring gear R1, and the second planetary gear set 2 includes a second sun gear S2, a second carrier C2, and a second ring gear R2.

Preferably, the first fixing mechanism and the second fixing mechanism are a first brake BK1 and a second brake BK2 which can restrict rotation of the rotary members connected thereto, respectively, and the third torque transmission mechanism and the fourth torque transmission mechanism are a first clutch CL1 and a second clutch CL2 which can selectively connect and disconnect two rotary members that can relatively rotate.

Further, the second clutch CL2 is disposed to selectively connect/disconnect the first carrier C1 and the ring gear R1 of the first planetary gear set 1, the first brake BK1 is disposed to restrict rotation of the second ring gear R2, the second brake BK2 is disposed to restrict rotation of the second sun gear S2, the second motor generator MG2 is continuously connected to the second sun gear S2, and the output member OUTPUT is connected to the second carrier C2.

According to the first embodiment shown in FIG. 1, the engine ENGINE is connected to the first carrier C1, the first motor generator MG1 is connected to the first sun gear S1-2, the first sun gear S1-1 is continuously connected to the second sun gear S2, and the first clutch CL1 selectively connects the first ring gear R1 with the second carrier C2.

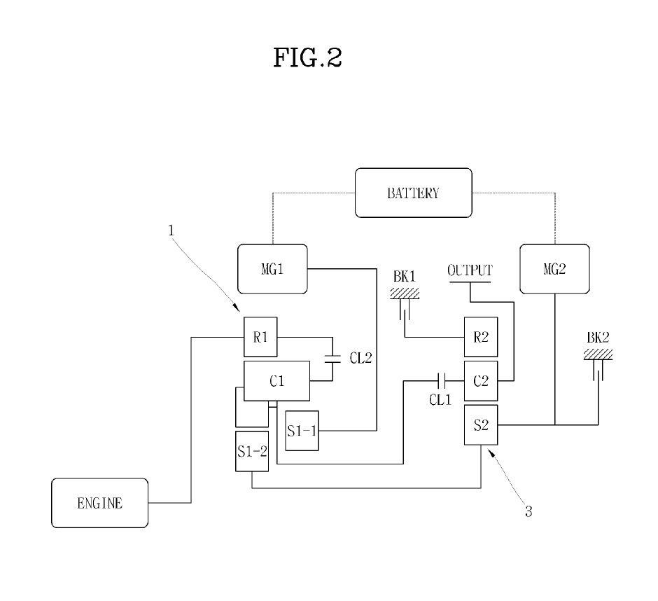

On the other hand, according to the second embodiment shown in FIG. 2, the engine ENGINE is connected to the first ring gear R1, the first motor generator MG1 is connected to the first sun gear S1-1, the first sun gear S1-2 is continuously connected to the second sun gear S2, and the first clutch CL1 selectively connects the first carrier C1 with the second carrier C2.

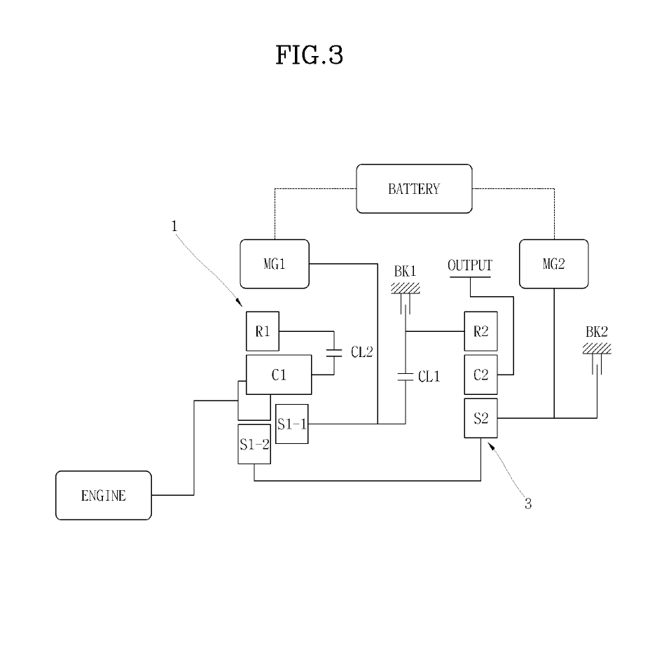

According to the third embodiment shown in FIG. 3, the engine ENGINE is connected to the first carrier C1, the first motor generator MG1 is connected to the first sun gear S1-1, the first sun gear S1-2 is continuously connected to the second sun gear S2, and the first clutch CL1 selectively connects the first sun gear S1-1 with the second ring gear R2.

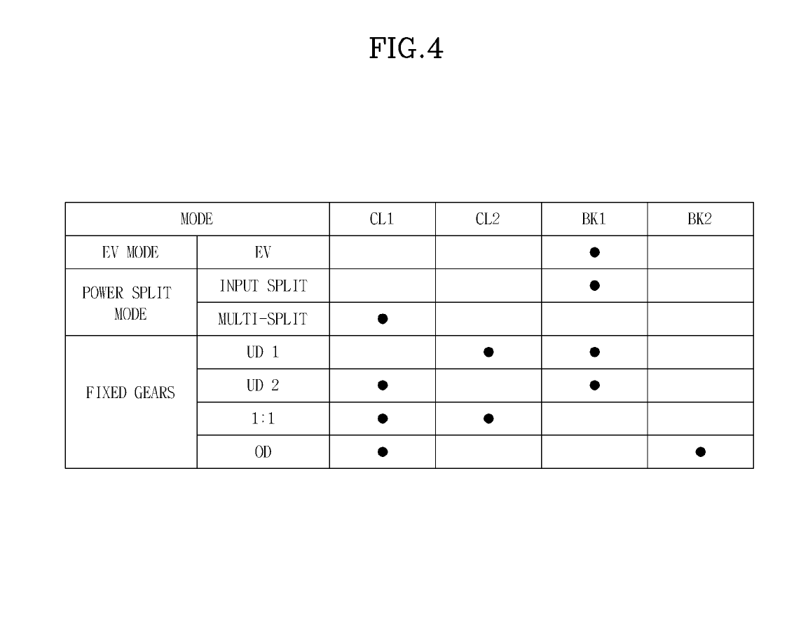

The operation of the transmission according to the first embodiment shown in FIG. 1 is described with reference to FIGS. 4 to 12.

FIG. 4 is a table showing operation modes of the first embodiment shown in FIG. 1, which include an EV mode (EV), an input split mode, a multi-split mode, a first under drive fixed-gear mode (UD1), a second under drive fixed-gear mode (UD2), a 1:1 fixed-gear mode (1:1), and an over drive fixed-gear mode (OD).

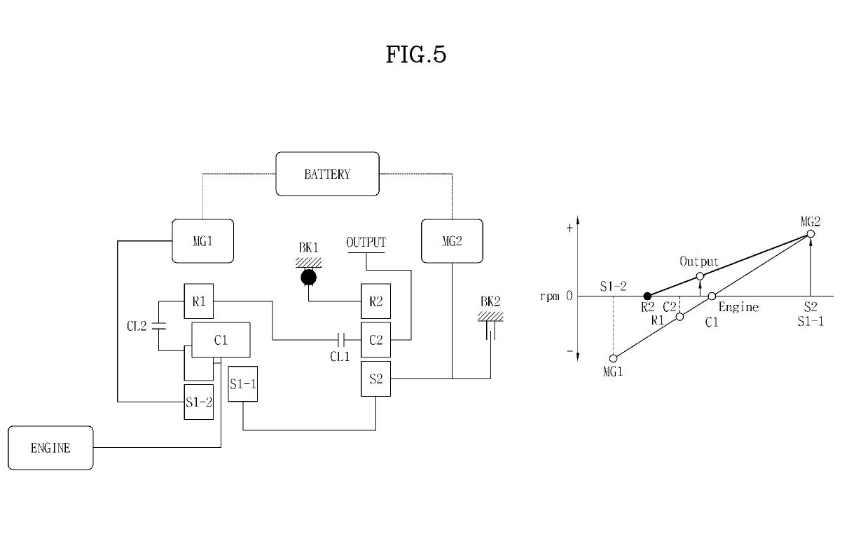

FIG. 5 illustrates the EV mode, which is implemented by engaging the first brake BK1 with the engine ENGINE stopped.

In this mode, the second ring gear R2 is fixed by the first brake BK1. Accordingly, as the second motor generator MG2 drives the second sun gear S2, the power is reduced through the second ring gear C2 and outputted to the output member OUTPUT connected with the driving wheels.

In this operation, the first sun gear S1-1 is also driven by the second motor generator MG2 and the engine ENGINE is in stop. Accordingly, the first motor generator MG1 is freely reversed by the first sun gear S1-2.

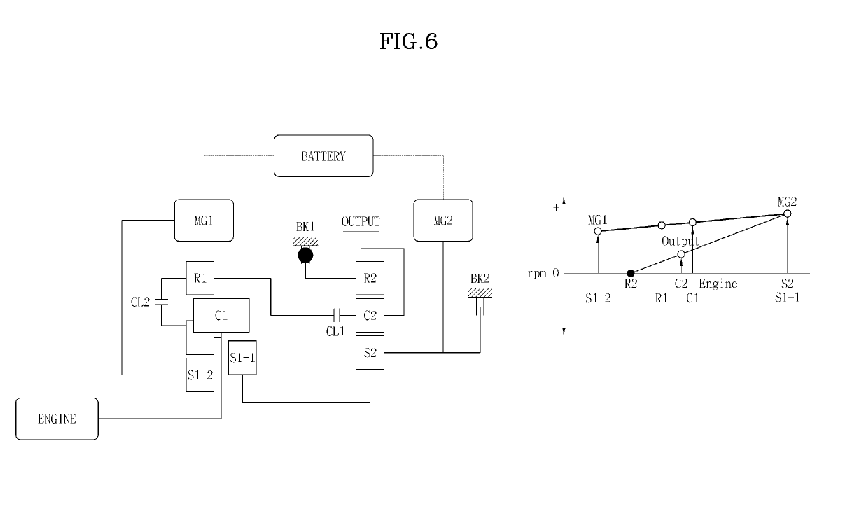

FIG. 6 illustrates when the engine ENGINE starts in the EV mode. This mode is switched into the hybrid mode by driving the first motor generator MG1 to increase the revolution number of the engine ENGINE and then starting the engine ENGINE, with only the first brake BK1 engaged in the EV mode.

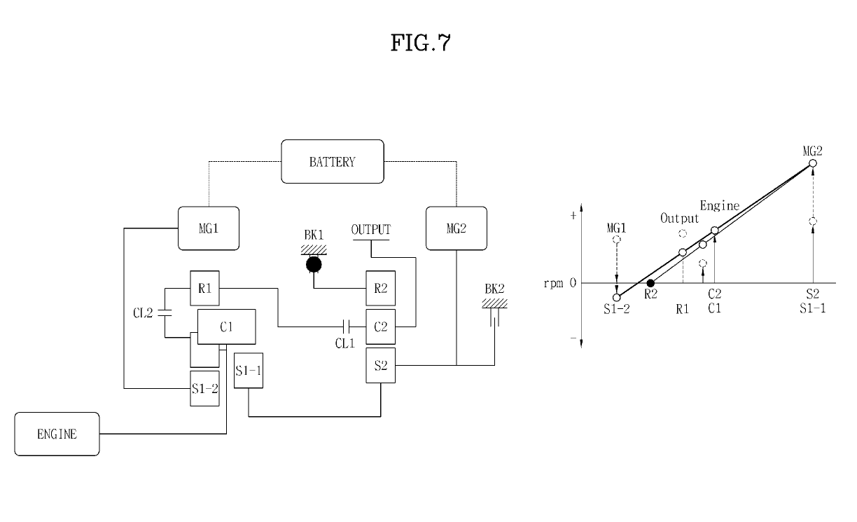

FIG. 7 illustrates the input split mode, in which the transmission operates as an EVT.

With only the first brake BK1 engaged, the vehicle is driven by the power from the engine ENGINE and the power from the second motor generator MG2, and the first motor generator MG1 generates electricity or circulates power, depending on circumstances.

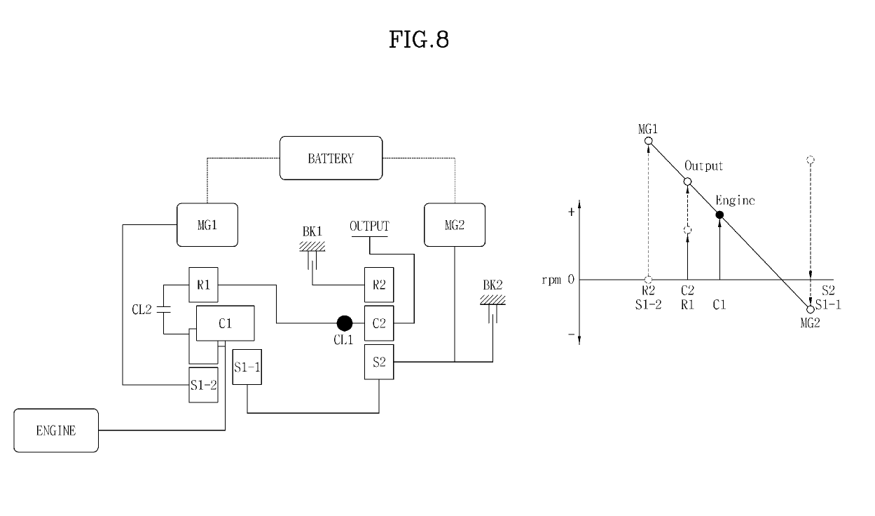

FIG. 8 illustrates the multi-split mode, which is implemented by engaging the first clutch CL1. In this mode, two rotary members are integrated in the first planetary gear set 1 and the second planetary gear set 2 by the first clutch CL1 and one lever is formed. Accordingly, the vehicle is driven by the first motor generator MG1 and the engine ENGINE and the second motor generator MG2 generates electricity or circulates power, depending on circumstances.

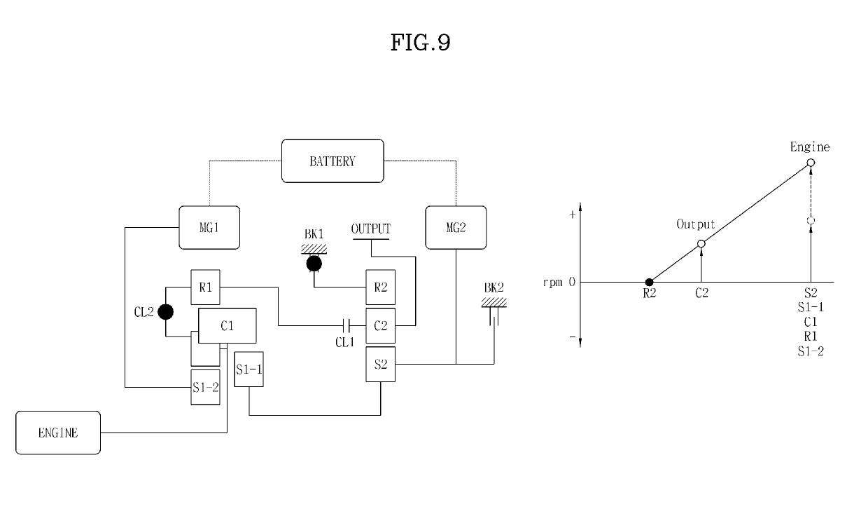

FIG. 9 illustrates the UD1 mode, which is implemented by engaging the first brake BK1 with the second clutch CL2.

In this mode, the first planetary gear set 1 is integrated by the engagement of the second clutch CL2 and the second ring gear R2 is fixed by the engagement of the first brake Bkl. Accordingly, the power of the engine ENGINE is supplied to the first carrier C1 and the entire planetary gear set 1 is rotated. Further, the power drives the second sun gear S2 of the second planetary gear set 2 and is reduced and outputted through the second carrier C2, in which the first motor generator MG1 and the second motor generator MG2 freely rotate with the engine ENGINE. As a result, the power from the engine ENGINE is reduced and outputted at a predetermined reduction ratio of the second planetary gear set 2.

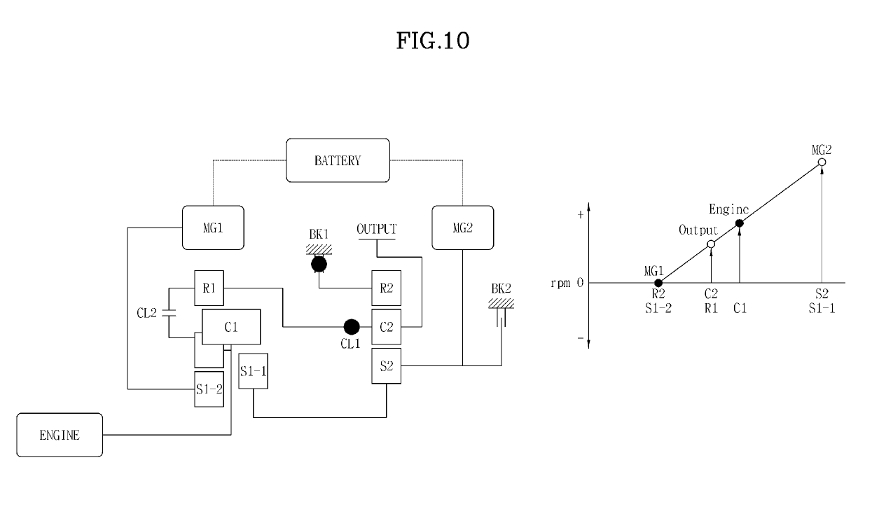

FIG. 10 illustrates the UD2 mode, which is implemented by engaging the first brake BK1 with the first clutch CL1.

As the first clutch CL1 is engaged, two members are directly connected in the first planetary gear set 1 and the second planetary gear set 2. Accordingly, one lever having a fixed-gear ratio is formed, as shown in the figure. Further, the power supplied from the engine ENGINE to the first carrier C1 is reduced across the first ring gear R1 and then transmitted to the output member through the first clutch CL1 and the second carrier C2.

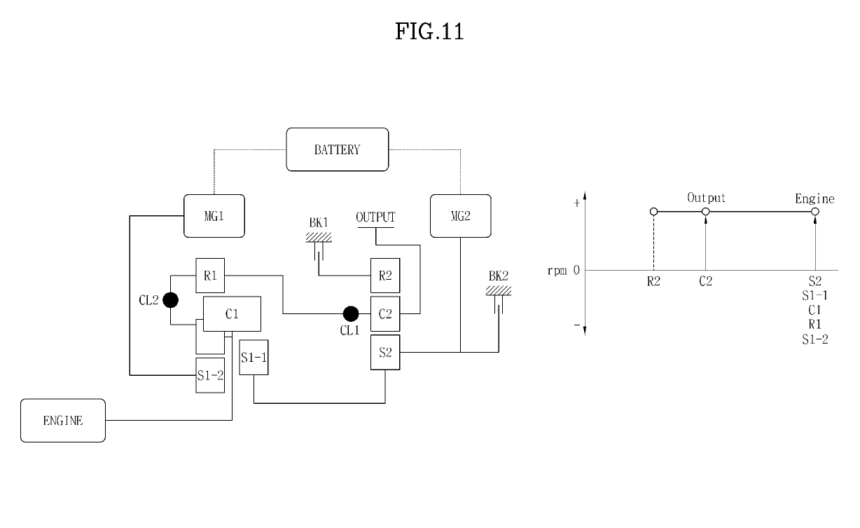

FIG. 11 illustrates the 1:1 mode, which is implemented by engaging the first clutch CL1 and the second clutch CL2. In this mode, the first planetary gear set 1 is integrated by the second clutch CL2 and the second planetary gear set 2 is integrated with the first planetary gear set by the first clutch CL1. Accordingly, the power inputted from the engine ENGINE to the first carrier C1 is outputted to the output member OUTPUT through the second carrier C2 without change.

Further, the first motor generator MG1 and the second motor generator MG2 freely rotate with the engine ENGINE.

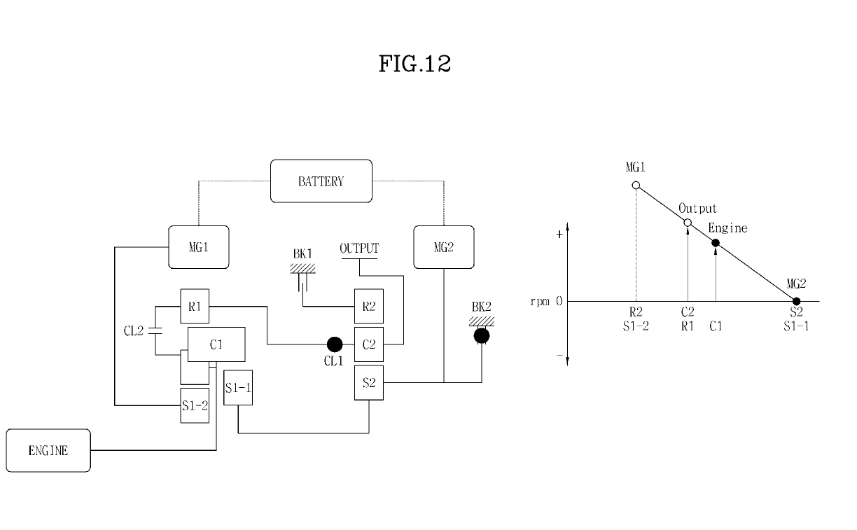

FIG. 12 illustrates the OD mode, which is implemented by engaging the second brake BK2 with the first clutch CL1.

That is, the first planetary gear set 1 and the second planetary gear set 2 form one lever by the engagement of the first clutch CL1, and the second sun gear S2 and the first sun gear S1-1 are both fixed. Accordingly, the power supplied from the engine ENGINE to the first carrier C1 is increased and outputted across the first ring gear R1.

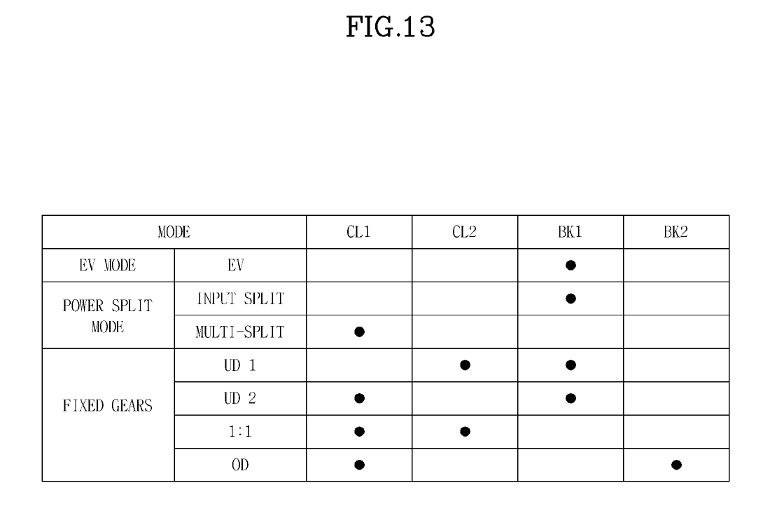

The operation of the transmission according to the second embodiment shown in FIG. 2 is described with reference to FIGS. 13 to 21.

FIG. 13 is a table showing operation modes of the second embodiment shown in FIG. 2, which include an EV mode, an input split mode, a multi-split mode, a UD1 mode, a UD2 mode, a 1:1 mode, and an OD mode.

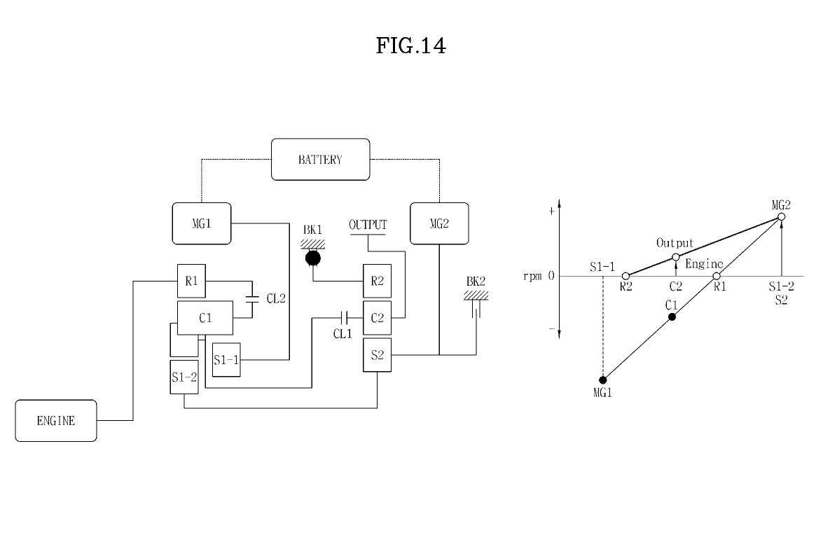

FIG. 14 illustrates the EV1 mode, which is implemented by engaging the first brake BK1 with the engine ENGINE stopped.

In this mode, the second ring gear R2 is fixed by the first brake BK1. Accordingly, as the second motor generator MG2 drives the second sun gear S2, the power is reduced through the second ring gear C2 and outputted to the output member OUTPUT connected to the driving wheels.

In this operation, the first sun gear S1-2 is also driven by the second motor generator MG2 and the engine ENGINE is in stop. Accordingly, the first motor generator MG1 is freely reversed by the first sun gear S1-2.

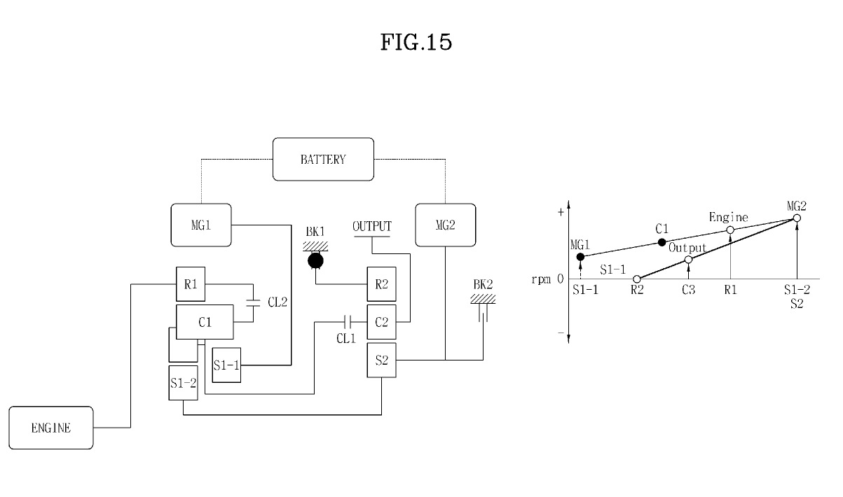

FIG. 15 illustrates when the engine ENGINE starts in the EV1 mode. The mode is switched into the hybrid mode in which the engine ENGINE and the motor generators supply power together with each other, by driving the first motor generator MG1 to increase the revolution number of the engine ENGINE and then starting the engine ENGINE, with only the first brake BK1 engaged in the EV1 mode.

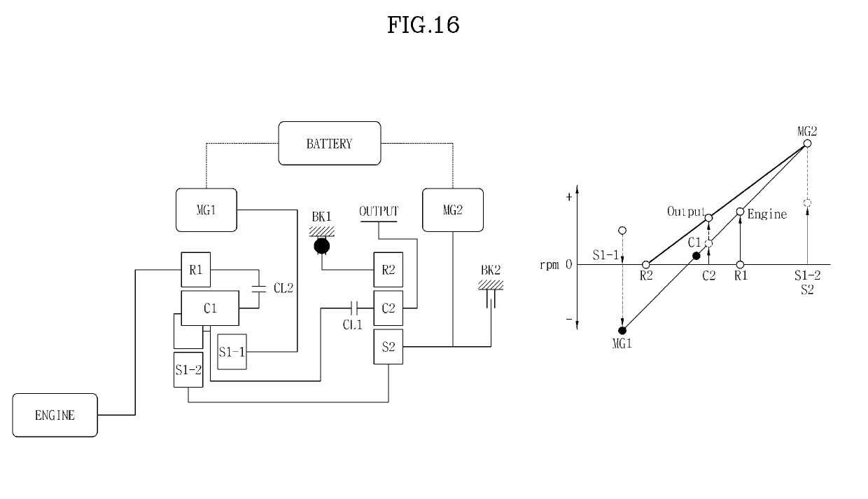

FIG. 16 illustrates the input split mode, in which the transmission of the present invention operates as an EVT.

With only the first brake BK1 engaged, the vehicle is driven by the power from the engine ENGINE and the power from the second motor generator MG2, and the first motor generator MG1 generates electricity or circulates power, depending on circumstances.

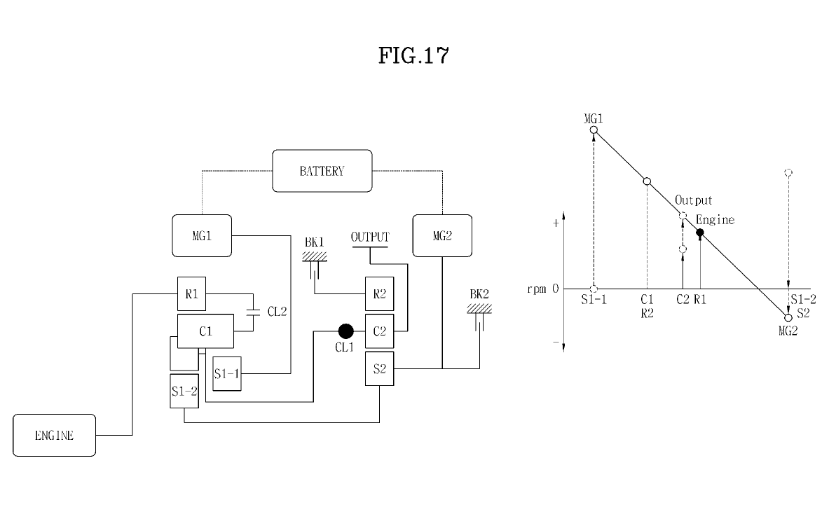

FIG. 17 illustrates the multi-split mode, which is implemented by engaging the first clutch CL1. In this mode, two rotary members are integrated in the first planetary gear set 1 and the second planetary gear set 2 by the first clutch CL1 and one lever is formed. Accordingly, the vehicle is driven by the first motor generator MG1 and the engine ENGINE and the second motor generator MG2 generates electricity or circulates power, depending on circumstances.

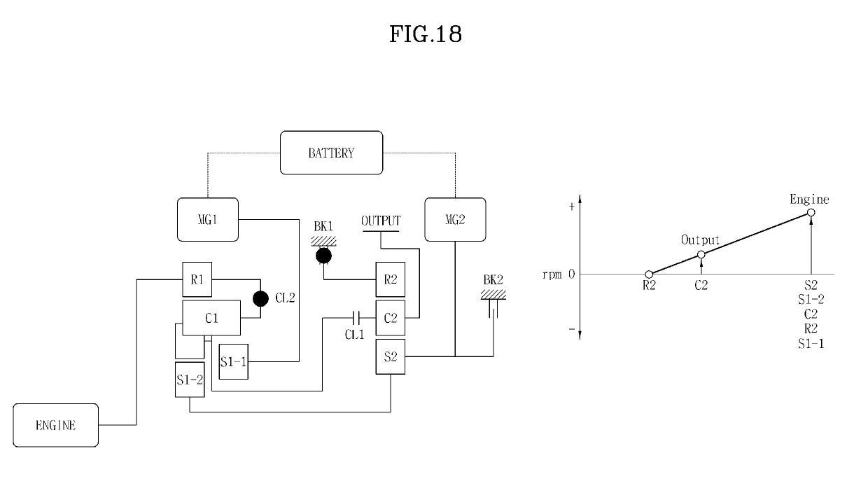

FIG. 18 illustrates the UD1 mode, which is implemented by engaging the first brake BK1 with the second clutch CL2.

The first planetary gear set 1 is integrated by the engagement of the second clutch CL2 and the second ring gear R2 is fixed by the engagement of the first brake BK1. Accordingly, the power of the engine ENGINE is supplied to the first ring gear R1 and the entire planetary gear set 1 is rotated. Further, the power drives the second sun gear S2 of the second planetary gear set 2 and is reduced and outputted through the second carrier C2, in which the first motor generator MG1 and the second motor generator MG2 freely rotate with the engine ENGINE. As a result, the power from the engine ENGINE is reduced and outputted at a predetermined reduction ratio of the second planetary gear set 2.

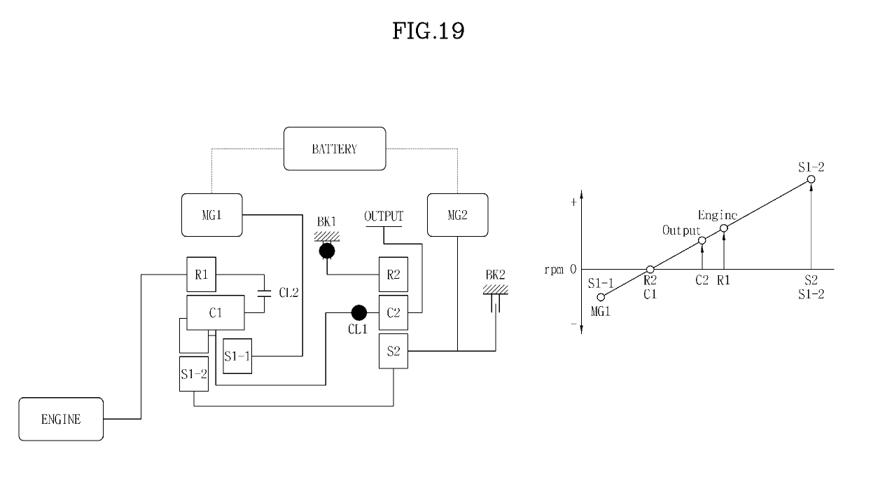

FIG. 19 illustrates the UD2 mode, which is implemented by engaging the first brake BK1 with the first clutch CL1.

As the first clutch CL1 is engaged, two members are directly connected in the first planetary gear set 1 and the second planetary gear set 2. Accordingly, one lever having a fixed-gear ratio is formed, as shown in the figure. Further, the power supplied from the engine ENGINE to the first ring gear R1 is reduced across the first carrier C1 and then transmitted to the output member through the first clutch CL1 and the second carrier C2.

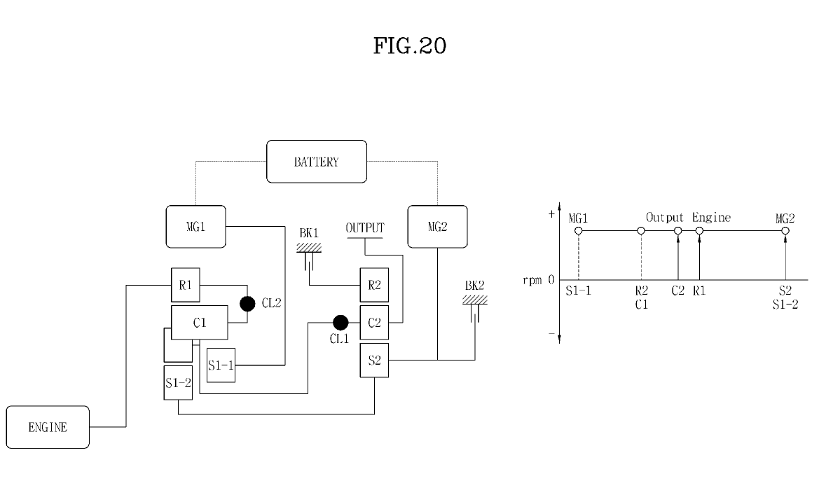

FIG. 20 illustrates the 1:1 mode, which is implemented by engaging the first clutch CL1 and the second clutch CL2. In this mode, the first planetary gear set 1 is integrated by the second clutch CL2 and the second planetary gear set 2 is integrated with the first planetary gear set by the first clutch CL1. Accordingly, the power inputted from the engine ENGINE to the first ring gear R1 is outputted to the output member OUTPUT through the second carrier C2 without change.

Further, the first motor generator MG1 and the second motor generator MG2 freely rotate with the engine ENGINE.

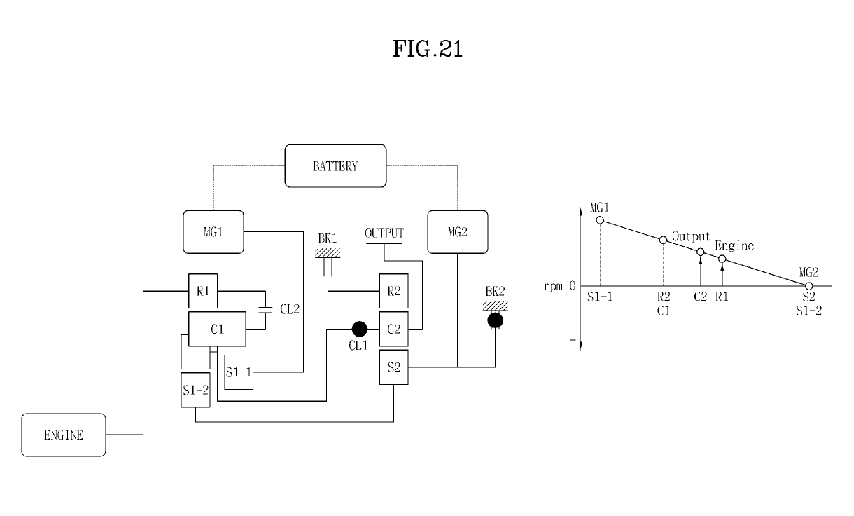

FIG. 21 illustrates the OD mode, which is implemented by engaging the second brake BK2 with the first clutch CL1.

That is, the first planetary gear set 1 and the second planetary gear set 2 form one lever by the engagement of the first clutch CL1, and the second sun gear S2 and the first sun gear S1-2 are both fixed. Accordingly, the power supplied from the engine ENGINE to the first ring gear R1 is increased and outputted across the first carrier C1.

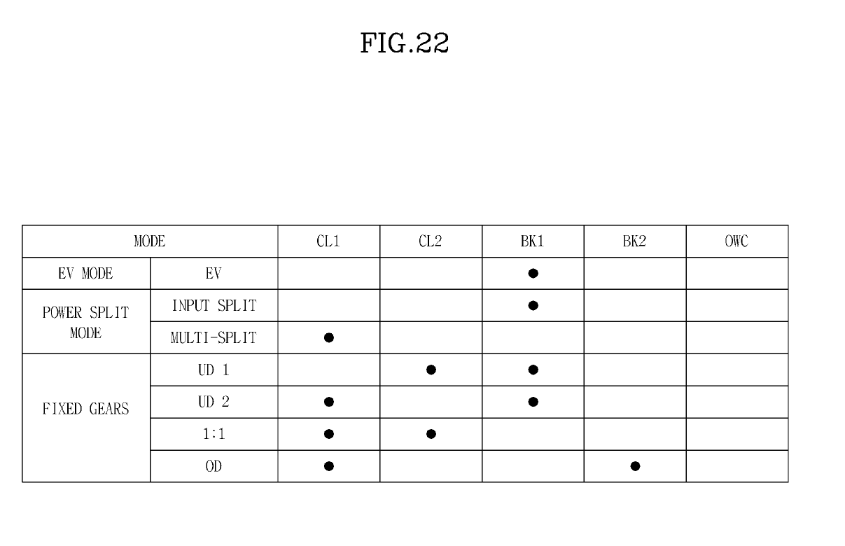

The operation of the transmission according to the third embodiment shown in FIG. 3 is next described with reference to FIGS. 22 to 29.

FIG. 22 is a table showing operation modes of the third embodiment shown in FIG. 3, which includes an EV mode, an input split mode, a multi-split mode, a UD1 mode, a UD2 mode, a 1:1 mode, and an OD mode.

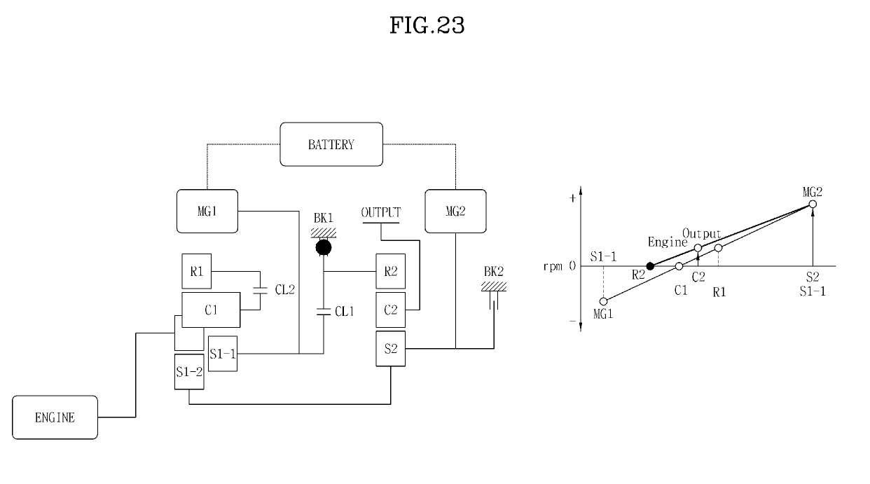

FIG. 23 illustrates the EV1 mode, which is implemented by engaging the first brake BK1 with the engine ENGINE stopped.

In this mode, the second ring gear R2 is fixed by the first brake BK1. Accordingly, as the second motor generator MG2 drives the second sun gear S2, the power is reduced through the second ring gear C2 and outputted to the output member OUTPUT connected to the driving wheels.

In this operation, the first sun gear S1-2 is also driven by the second motor generator MG2 and the engine ENGINE is in stop. Accordingly, the first motor generator MG1 is freely reversed by the first sun gear S1-2.

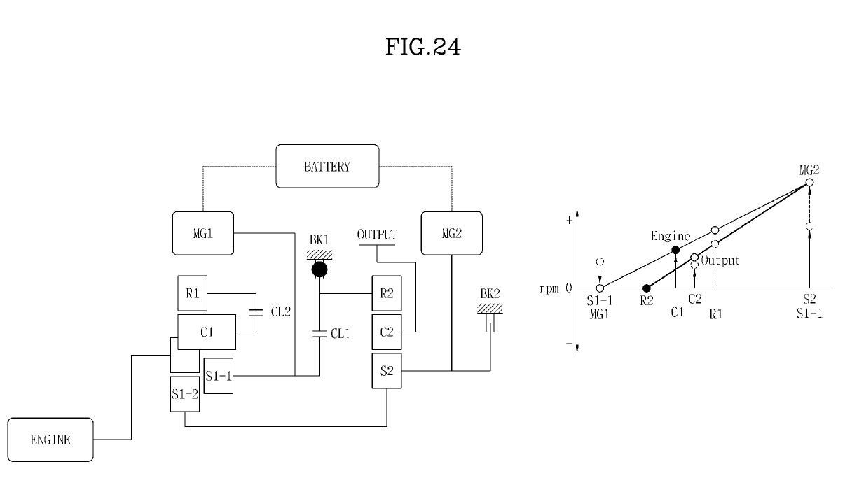

FIG. 24 illustrates the input split mode, in which the transmission of the present invention operates as an EVT.

With only the first brake BK1 engaged, the vehicle is driven by the power from the engine ENGINE and the power from the second motor generator MG2, and the first motor generator MG1 generates electricity, depending on circumstances.

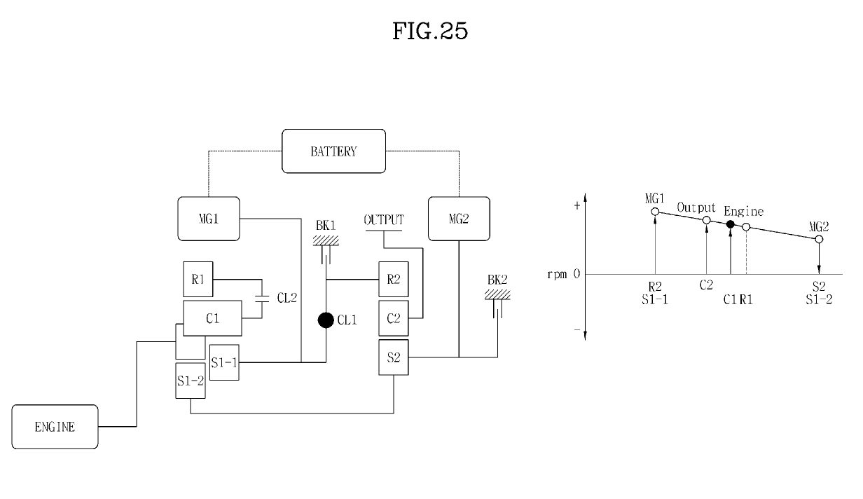

FIG. 25 illustrates the multi-split mode, which is implemented by engaging the first clutch CL1. In this mode, two rotary members are integrated in the first planetary gear set 1 and the second planetary gear set 2 by the first clutch CL1 and one lever is formed. Accordingly, the vehicle is driven by the first motor generator MG1 and the engine ENGINE and the second motor generator MG2 generates electricity.

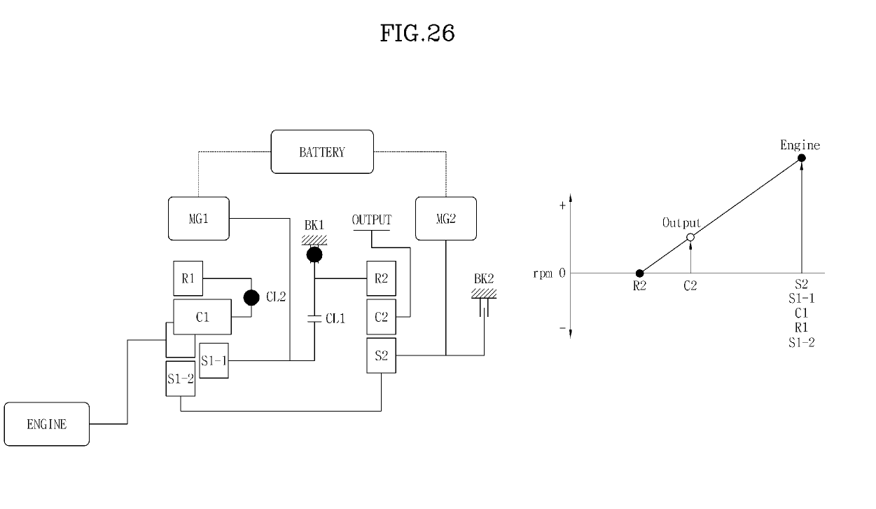

FIG. 26 illustrates the UD1 mode, which is implemented by engaging the first brake BK1 with the second clutch CL2.

The first planetary gear set 1 is integrated by the engagement of the second clutch CL2 and the second ring gear R2 is fixed by the engagement of the first brake BK1. Accordingly, the power of the engine ENGINE is supplied to the first carrier C1 and the entire planetary gear set 1 is rotated. Further, the power drives the second sun gear S2 of the second planetary gear set 2 and is reduced and outputted through the second carrier C2, in which the first motor generator MG1 and the second motor generator MG2 freely rotate with the engine ENGINE. As a result, the power from the engine ENGINE is reduced and outputted at a predetermined reduction ratio of the second planetary gear set 2.

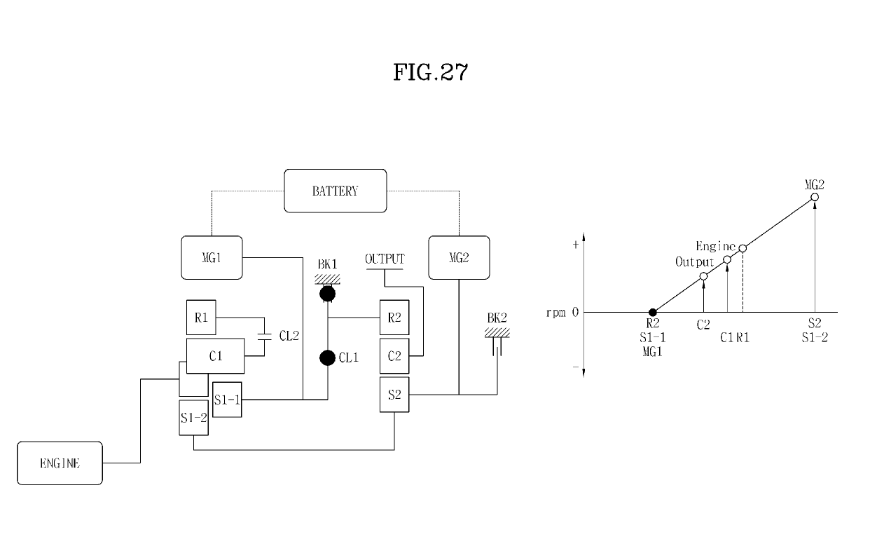

FIG. 27 illustrates the UD2 mode, which is implemented by engaging the first brake BK1 with the first clutch CL1.

As the first clutch CL1 is engaged, two members are directly connected in the first planetary gear set 1 and the second planetary gear set 2. As a result, one lever having a fixed-gear ratio is formed and the second ring gear R2 and the first sun gear S1-1 are both fixed, as shown in the figure. Accordingly, the power supplied from the engine ENGINE to the first carrier C1 is transmitted to the second sun gear S2 through the first sun gear S1-2 and the power of the second sun gear S2 is reduced across the second carrier C2 and transmitted to the output member.

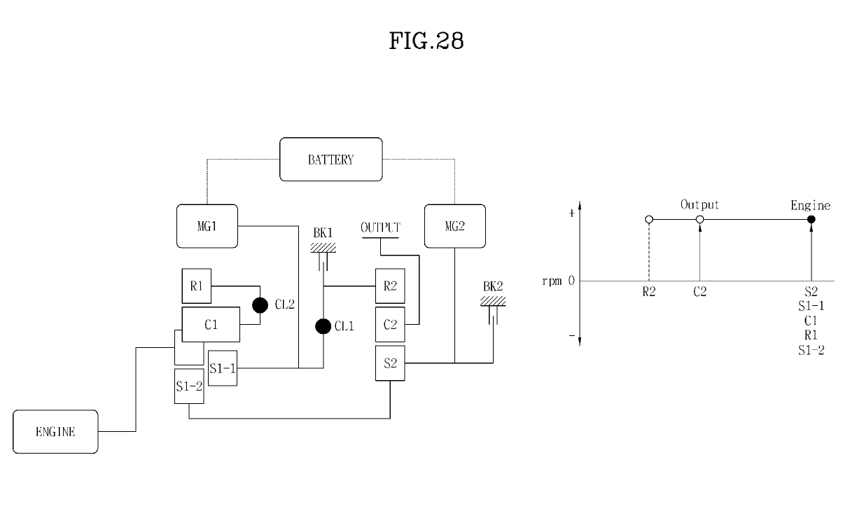

FIG. 28 illustrates the 1:1 mode, which is implemented by engaging the first clutch CL1 and the second clutch CL2. In this mode, the first planetary gear set 1 is integrated by the second clutch CL2 and the second planetary gear set 2 is integrated with the first planetary gear set by the first clutch CL1. Accordingly, the power inputted from the engine ENGINE to the first carrier C1 is outputted to the output member OUTPUT through the second carrier C2 without change.

Further, the first motor generator MG1 and the second motor generator MG2 freely rotate with the engine ENGINE.

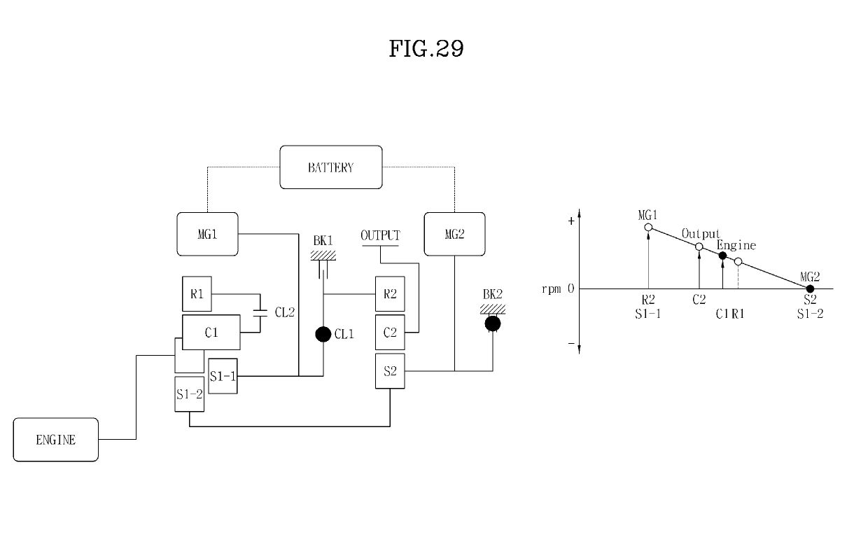

FIG. 29 illustrates the OD mode, which is implemented by engaging the second brake BK2 with the first clutch CL1.

That is, the first planetary gear set 1 and the second planetary gear set 2 form one lever by the engagement of the first clutch CL1, and the second sun gear S2 and the first sun gear S1-2 are both fixed. Accordingly, the power supplied from the engine ENGINE to the first carrier C1 is transmitted to the second ring gear R2 through the first sun gear S1-1 and the power of the second ring gear R2 is increased and outputted across the second carrier C2.

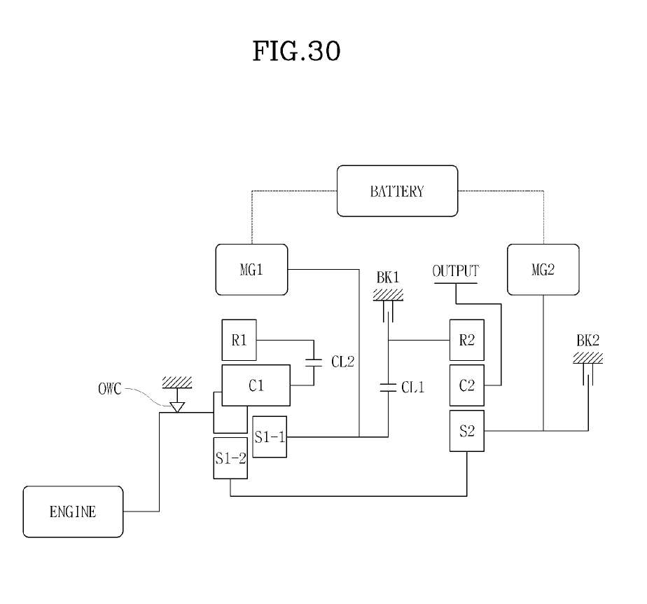

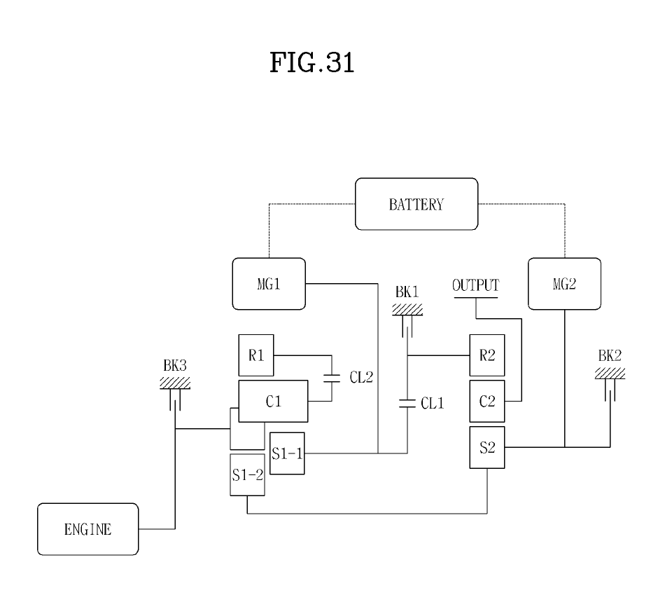

On the other hand, FIGS. 30 and 31 illustrate modified embodiments of the first embodiment shown in FIG. 3, in which a selective restricting member is further included between the engine ENGINE and the first carrier C1 to selectively restrict rotation of the engine ENGINE.

In the embodiment shown in FIG. 30, the selective restricting member is implemented by a one-way clutch OWC disposed between the engine ENGINE and the first carrier C1 to prevent reverse of the engine ENGINE, and in the embodiment shown in FIG. 31, it is implemented by a third brake BK3 to selective restrict rotation of the first carrier C1.

It is possible to implement an electric vehicle mode other than the EV mode by using one-way clutch OWC or third brake BK3, as described above. In this case, as the first planetary gear set 1 and the second planetary gear set 2 form one straight lever by engaging the first clutch CL1, the engine ENGINE is fixed by one-way clutch OWC or third brake BK3. Accordingly, the vehicle can travel in the EV mode by appropriately driving the first motor generator MG1 and the second motor generator MG2 in opposite directions. Further, since the first motor generator MG1 and the second motor generator MG2 can be driven under conditions with higher efficiency than the EV mode, the fuel economy of the vehicle can be relatively improved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A transmission for a hybrid vehicle, comprising:
a first differential gear set that includes at least four rotary members, including a rotary member connected to an engine and two rotary members selectively connected with each other;
a second differential gear set that includes at least three rotary members, including a rotary member continuously connected to a rotary member of the first differential gear set and two rotary members each being connected to an output member, selectively connected to another rotary member of the first differential gear set, or both;
a first motor generator that is continuously connected to a rotary member of the first differential gear set other than the rotary member connected to the engine and the rotary members selectively connected with each other;
a second motor generator that is continuously connected to the rotary member of the second differential gear set continuously connected to the rotary member of the first differential gear set;
a first fixing mechanism that is provided to restrict rotation of a rotary member of the second differential gear set other than the rotary member connected to the output member and the rotary member connected to the second motor generator; and
a second fixing mechanism that is provided to restrict rotation of the rotary member of the second differential gear set connected with the second motor generator.

2. The transmission for a hybrid vehicle as defined in claim 1, wherein a rotary member of the second differential gear set is selectively connected to a rotary member of the first differential gear set through a third torque converter, and
two rotary members of the first differential gear set can be selectively connected with each other through a fourth torque converter.

3. The transmission for a hybrid vehicle as defined in claim 2, wherein the first differential gear set is a revenue type planetary gear set,
the second differential gear set is a simple planetary gear set,
the first differential gear set includes a 1-1 sun gear, a 1-2 sun gear, a first carrier, and a first ring gear, and
the second differential gear set includes a second sun gear, a second carrier, and a second ring gear.

4. The transmission for a hybrid vehicle as defined in claim 3, wherein the first fixing mechanism and the second fixing mechanism are a first brake and a second brake which restrict the rotary members connected thereto, respectively, and
the third torque converter and the fourth torque converter are a first clutch and a second clutch which selectively connect/disconnect two rotary members relatively rotating, respectively.

5. The transmission for a hybrid vehicle as defined in claim 4, wherein the second clutch is disposed to selectively connect/disconnect the first carrier and the first ring gear,
the first brake is disposed to restrict rotation of the second ring gear,
the second brake is disposed to restrict rotation of the second sun gear,
the second motor generator is continuously connected to the second sun gear, and
the output member is connected to the second carrier.

6. The transmission for a hybrid vehicle as defined in claim 5, wherein the engine is connected to the first carrier,
the first motor generator is connected to the 1-2 sun gear,
the 1-1 sun gear is continuously connected to the second sun gear, and
the first clutch selectively connects the first ring gear with the second carrier.

7. The transmission for a hybrid vehicle as defined in claim 5, wherein the engine is connected to the first ring gear,
the first motor generator is connected to the 1-1 sun gear,
the 1-2 sun gear is continuously connected to the second sun gear, and
the first clutch selectively connects the first carrier with the second carrier.

8. The transmission for a hybrid vehicle as defined in claim 5, wherein the engine is connected to the first carrier,
the first motor generator is connected to the 1-1 sun gear,
the 1-2 sun gear is continuously connected to the second sun gear, and
the first clutch selectively connects the 1-1 sun gear with the second ring gear.

9. The transmission for a hybrid vehicle as defined in claim 8, further comprising a selective restricting member that is disposed between the engine and the first carrier to selectively restrict rotation of the engine.

10. The transmission for a hybrid vehicle as defined in claim 9, wherein the selective restricting member is a one-way clutch disposed between the engine and the first carrier to prevent the engine from reversing.

11. The transmission for a hybrid vehicle as defined in claim 9, wherein the selective restricting member is a third brake disposed to selectively restrict rotation of the first carrier.

12. A transmission for a hybrid vehicle, comprising:
a first planetary gear set that includes at least four rotary members including a rotary member connected to an engine and two rotary members selectively connected with each other;
a second planetary gear set that includes at least three rotary members including a rotary member continuously connected to a rotary member of the first differential gear set and two rotary members each being connected to an output member OUTPUT, selectively connected to another rotary member of the first differential gear set, or both;
a first fixing mechanism and a second fixing mechanism that restrict rotation of two rotary members of the second planetary gear set, respectively, other than the rotary member connected to the output member;
a third torque converter that selectively connects/disconnects a rotary member of the first planetary gear set and a rotary member of the second planetary gear set;
a fourth torque converter that selectively connects/disconnects two rotary members of the first planetary gear set;
a first motor generator that is connected to a rotary member of the first planetary gear set; and
a second motor generator that is connected to a rotary member of the second planetary gear set.

13. The transmission for a hybrid vehicle as defined in claim 12, wherein the first planetary gear set is a revenue type planetary gear set,
the second planetary gear set is a simple planetary gear set,
the first planetary gear set includes a 1-1 sun gear, a 1-2 sun gear, a first carrier, and a first ring gear, and
the second planetary gear set includes a second sun gear, a second carrier, and a second ring gear.

14. The transmission for a hybrid vehicle as defined in claim 13, wherein the first fixing mechanism and the second fixing mechanism are a first brake and a second brake which restrict the rotary members connected thereto, respectively, and
the third torque converter and the fourth torque converter are a first clutch and a second clutch which selectively connect/disconnect two rotary members relatively rotating, respectively.

15. The transmission for a hybrid vehicle as defined in claim 14, wherein the second clutch is disposed to selectively connect/disconnect the first carrier and the first ring gear,
the first brake is disposed to restrict rotation of the second ring gear,
the second brake is disposed to restrict rotation of the second sun gear,
the second motor generator is continuously connected to the second sun gear, and
the output member is connected to the second carrier.

16. The transmission for a hybrid vehicle as defined in claim 15, wherein the engine is connected to the first carrier,
the first motor generator is connected to the 1-2 sun gear,
the 1-1 sun gear is continuously connected to the second sun gear, and
the first clutch selectively connects the first ring gear with the second carrier.

17. The transmission for a hybrid vehicle as defined in claim 15, wherein the engine is connected to the first ring gear,
the first motor generator is connected to the 1-1 sun gear,
the 1-2 sun gear is continuously connected to the second sun gear, and
the first clutch selectively connects the first carrier with the second carrier.

18. The transmission for a hybrid vehicle as defined in claim 15, wherein the engine is connected to the first carrier,
the first motor generator is connected to the 1-1 sun gear,
the 1-2 sun gear is continuously connected to the second sun gear, and
the first clutch selectively connects the 1-1 sun gear with the second ring gear.

19. The transmission for a hybrid vehicle as defined in claim 18, further comprising a selective restricting member that is disposed between the engine and the first carrier to selectively restrict rotation of the engine.

20. The transmission for a hybrid vehicle as defined in claim 19, wherein the selective restricting member is a one-way clutch disposed between the engine and the first carrier to prevent the engine from reversing.

21. The transmission for a hybrid vehicle as defined in claim 19, wherein the selective restricting member is a third brake disposed to selectively restrict rotation of the first carrier.
